(19) United States
(12) Patent Application Publication
(10) Pub. No.: US 2022/0250416 A1
(43) Pub. Date: Aug. 11, 2022

(54) HEAVY-DUTY PNEUMATIC TIRE

(71) Applicant: Sumitomo Rubber Industries, Ltd., Kobe-shi (JP)

(72) Inventor: Hidetoshi TANIGUCHI, Kobe-shi (JP)

(73) Assignee: Sumitomo Rubber Industries, Ltd., Kobe-shi (JP)

(21) Appl. No.: 17/582,319

(22) Filed: Jan. 24, 2022

(30) Foreign Application Priority Data
Feb. 8, 2021 (JP) 2021-018441

(51) Int. Cl. B60C 11/13

(52) U.S. Cl. CPC B60C 11/13; B60C 2011/0348; B60C 2200/06

(57) ABSTRACT

A heavy-duty pneumatic tire includes a tread portion including a pair of shoulder land portions. At least one of the pair of shoulder land portions is provided with a narrow groove extending continuously in the tire circumferential direction to divide the shoulder land portion into a main portion and a sacrificial rib located outward in the tire axial direction. The sacrificial rib includes a root portion in a tire radial direction with an axial width Wr, a top surface in the tire radial direction with an axial width Ws, and a ratio Wr/Ws being equal to or more than 1.0. In the shoulder land portion, a shortest distance Lw between the narrow groove and a maximum thickness line that defines a maximum thickness of the shoulder land portion measured in a normal direction to a tire cavity surface is equal to or less than 5.0 mm.

### RELATED APPLICATIONS

This application claims the benefit of foreign priority to Japanese Patent Application No. JP2021-018441, filed Feb. 8, 2021, which is incorporated by reference in its entirely.

### FIELD OF THE INVENTION

The present disclosure relates to a heavy-duty pneumatic tire.

### BACKGROUND OF THE INVENTION

Conventionally, heavy-duty pneumatic tires which include tread portions with shoulder land portions provided with narrow grooves to define narrow sacrificial ribs have been proposed (e.g., see Patent document 1). The sacrificial ribs can be expected to prevent the wear from spreading throughout the shoulder land portions by concentrating the wear on themselves.

### PATENT DOCUMENT

[Patent document 1] Japanese Unexamined Patent Application Publication 2002-36817

### SUMMARY OF THE INVENTION

In order to maintain the wear suppression effect of shoulder land portions for a long period of time, it is necessary to secure the rigidity of sacrificial ribs themselves and prevent the sacrificial ribs themselves from being damaged during running. From this point of view, it is preferable that the sacrificial ribs have a reasonable width or rubber volume.

On the other hand, shoulder land portions of heavy-duty pneumatic tires tend to generate heat during running because rubber volume as well as amount of deformation during load running of the shoulder land portions is large. Thus, increasing the size of the sacrificial ribs may cause a further increase in heat generation in the shoulder land portions during running, resulting in deteriorating the heat generation durability of tires.

The present disclosure has been made in view of the above circumstances and has a major object to provide a heavy-duty pneumatic tire capable of improving heat generation durability while maintaining wear suppression effect of a shoulder land portion.

In one aspect of the present disclosure, a heavy-duty pneumatic tire includes a tread portion being provided with a pair of shoulder circumferential grooves extending continuously in a tire circumferential direction and a pair of shoulder land portions disposed outward in a tire axial direction of the pair of shoulder circumferential grooves. At least one of the pair of shoulder land portions is provided with a narrow groove extending continuously in the tire circumferential direction to divide the at least one of the shoulder land portions into a main portion located inward in the tire axial direction and a sacrificial rib located outward in the tire axial direction. The sacrificial rib includes a root portion in a tire radial direction with a width Wr in the tire axial direction, a top surface in the tire radial direction with a width Ws in the tire axial direction, and a ratio Wr/Ws of the width Wr to the width Ws being equal to or more than 1.0. In the at least one of the pair of shoulder land portions, a shortest distance Lw between the narrow groove and a maximum thickness line that defines a maximum thickness of the at least one of the pair of shoulder land portions measured in a normal direction to a tire cavity surface is equal to or less than 5.0 mm.

### BRIEF DESCRIPTION OF THE DRAWINGS

FIG. 1 is a cross-sectional view of a heavy-duty pneumatic tire in accordance with an embodiment of the present disclosure;

FIG. 2 is a partial enlarged view of a shoulder land portion of FIG. 1;

FIG. 3 is a partial enlarged view of the shoulder land portion of FIG. 1;

FIG. 4 is a partial enlarged view of the shoulder land portion in accordance with another embodiment;

FIG. 5 is a partial enlarged view of the shoulder land portion in accordance with yet another embodiment;

FIG. 6 is a partial enlarged view of the shoulder land portion in accordance with yet another embodiment; and

FIG. 7 is a partial enlarged view of the shoulder land portion in accordance with yet another embodiment.

### DETAILED DESCRIPTION OF THE INVENTION

Hereinafter, one or more embodiments of the present disclosure will be described with reference to drawings. Note that throughout the embodiments of the present specification, the same or common elements are denoted by the same reference number and their detailed description is not repeated.

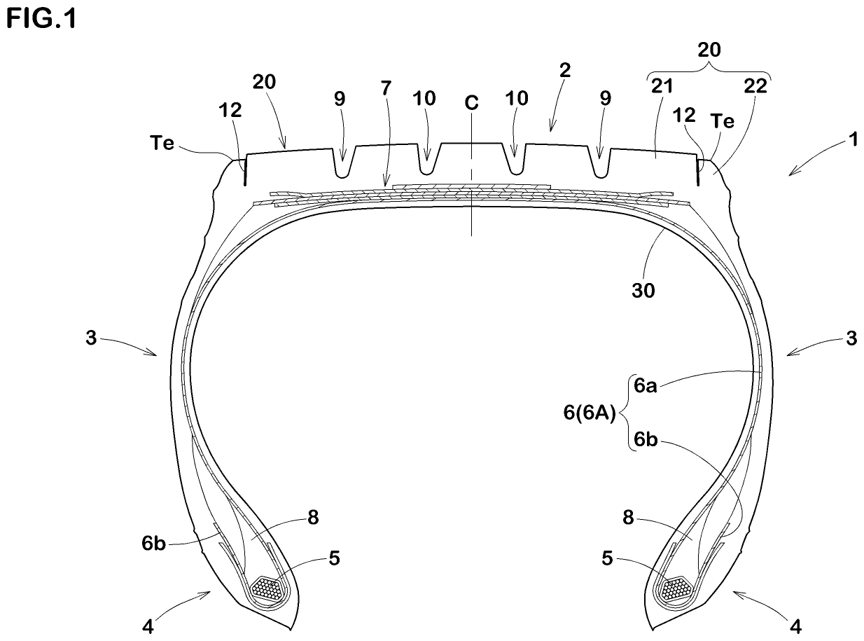

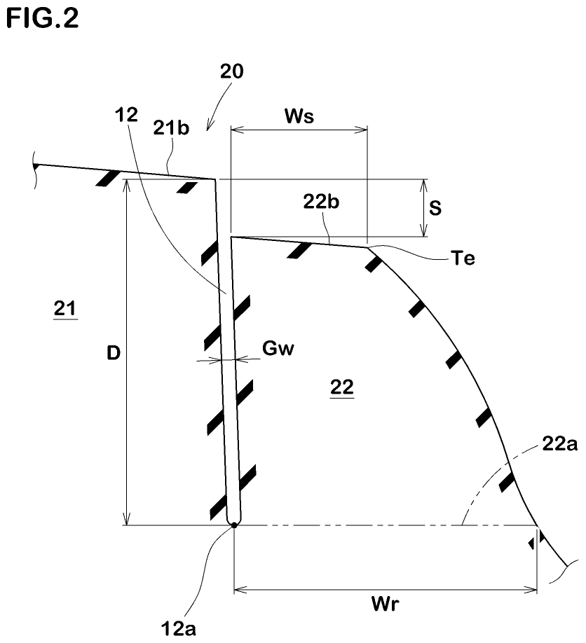

FIG. 1 is a cross-sectional view of a heavy-duty pneumatic tire (hereafter, simply referred to as “tire”) 1 in accordance with an embodiment, and FIG. 2 is a partial enlarged view of a shoulder land portion 20 of FIG. 1. In FIG. 1, the tire 1 is under a normal state.

As used herein, the “normal state” is such that the tire 1 is mounted onto a standard wheel rim with a standard internal pressure but loaded with no tire load. As used herein, unless otherwise specified, measurements of the portions of the tire 1 are values measured from the tire being under the normal state.

As used herein, the “standard wheel rim” is a wheel rim officially approved for each tire by standards organizations on which the tire 1 is based, wherein the standard wheel rim is the “standard rim” specified in JATMA, the “Design Rim” in TRA, and the “Measuring Rim” in ETRTO, for example.

As used herein, the “standard internal pressure” is a standard internal pressure officially approved for each tire by standards organizations on which the pneumatic tire 1 is based, wherein the standard internal pressure is the “maximum air pressure” in JATMA, the maximum pressure given in the “tire Load Limits at Various Cold Inflation Pressures” table in TRA, and the “Inflation Pressure” in ETRTO, for example.

As illustrated in FIG. 1, the tire 1 according to the present embodiment includes a tread portion 2, a pair of sidewall portions 3, and a pair of bead portions 4 each with a bead core therein. The tire 1 according to the present embodiment is configured as a pneumatic tire having an air-impermeable inner liner rubber arranged on the tire cavity surface 30.

The tire 1 further includes a carcass 6 extending between the bead cores 5 and 5, and a belt layer 7 disposed radially outward of the carcass 6.

In the present embodiment, the carcass 6, for example, includes at least one carcass ply 6A including a plurality of steel cords coated with a topping rubber. The plurality of carcass cords, for example, is oriented at an angle of from 80 to 90 degrees with respect to the tire equator, for example. Thus, the carcass 6 has a radial structure.

The carcass ply 6A, for example, includes a main portion 6a extending between the pair of bead cores 5, and a pair of turn-up portions 6b turned up around the bead cores 5 from axially inside to outside of the tire. In some preferred embodiments, a pair of bead apex rubbers 8 is disposed between the main portion 6a and the pair of turn-up portions 6b in the bead portions 4. The bead apex rubbers 8 are made of a hard rubber and extend radially outward in a tapered manner from outer surfaces of the bead cores 5.

The belt layer 7 includes a plurality of belt plies, e.g., four plies in the present embodiment. The bely plies each include a plurality of steel cords oriented at an angle of from 10 to 60 degrees with respect to the tire equator C, for example. Such a belt layer 7 can tighten the carcass 6 (i.e., hoop effect) and increase rigidity of the tread portion 2.

The tread portion 2 is provided with a plurality of circumferential grooves extending continuously in the tire circumferential direction. In the present embodiment, the circumferential grooves include a pair of shoulder circumferential grooves 9, and one or more crown circumferential grooves 10. The circumferential grooves 9 and 10 have a sufficient large groove width so that the grooves do not close when the tire 1 comes into contact with the ground with a standard tire load. As used herein, “standard tire load” is a tire load officially approved for each tire by standards organizations in which the tire 1 is based, wherein the standard tire load is the “maximum load capacity” in JATMA, the maximum value given in the above-mentioned table in TRA, and the “Load Capacity” in ETRTO, for example.

A groove width of the circumferential grooves 9 and 10 is not particularly limited. The groove width, for example, is equal to or more than 5 mm, preferably equal to or more than 6 mm, but preferably equal to or less than 15 mm. A groove depth of the circumferential grooves 9 and 10, for example, is equal to or more than 8 mm, more preferably equal to or more than 10 mm, but preferably equal to or less than 18 mm.

The tread portion 2 includes a pair of shoulder land portions 20 disposed outward in the tire axial direction of the pair of shoulder circumferential grooves 9. Each of the pair of shoulder land portions 20 includes a respective tread edge Te. Thus, the shoulder land portions 20 form axially outermost land portions in the tread portion 2. As used herein, “tread edges” are the axial outermost edges of the ground contacting patch of the tire 1 which occurs under a condition such that the tire 1 being under the normal state is grounded on a plane with the standard tire load at zero camber angles.

At least one of the pair of shoulder land portions 20 is provided with a narrow groove 12 extending continuously in the circumferential direction. In the present embodiment, as a preferred embodiment, each of the pair of shoulder land portions 20 is provided with the narrow groove 12.

The narrow groove 12 is located closer to the tread edge Te than the shoulder groove 9 in each shoulder land portion 20. Thus, each shoulder land portion is divided into a main portion 21 located inward in the tire axial direction and a sacrificial rib 22 located outward in the tire axial direction.

As illustrated in FIG. 2, the sacrificial rib 22 forms an axially end portion of the shoulder land portion 20 so as to include the tread edge Te. In addition, since the sacrificial rib 22 has a smaller width in the tire axial direction than that of the main portion 21, rigidity of the sacrificial rib 22 is also lower than that of the main portion 21. Such a sacrificial rib 22 can deform moderately during running and concentrate the wear on itself. Thus, it is possible to prevent the wear from spreading throughout the main portion 21.

Preferably, the narrow groove 12 has a groove width Gw such that a pair of groove walls comes into contact with each other when the tire 1 grounds receiving the standard tire load. Thus, when the tire 1 is driving, the sacrificial rib 22 can be brought into contact with the main portion 21 while ensuring the deformation of the sacrificial rib 22. As a result, the wear energy acting on the main portion 21 can be reduced, and uneven wear thereon can be suppressed. From the above view point, although the groove width Gw of the narrow groove 12 is not limited, the groove width Gw is preferably in a range of from 0.3 to 6.0 mm, for example. Similarly, a groove depth D of the narrow groove 12 is preferably in a range of from 10 to 18 mm, for example. Note that the narrow groove 12 according to the present embodiment has a substantially constant groove width Gw.

When the rigidity of the sacrificial rib 22 becomes small, damage such as defects and cracks may occur on the sacrificial rib 22 even though the tire has a sufficient wear life. Thus, in order to maintain wear suppression effect of the shoulder land portion 20 for a long period of time, it is necessary to ensure the rigidity of the sacrificial rib 22 itself. Under such a problem, as illustrated in FIG. 2, the sacrificial rib 22 according to the present embodiment has a root portion 22a in the tire radial direction with a width Wr in the tire axial direction, a top surface 22b in the tire radial direction with a width Ws in the axial direction, and a ratio Wr/Ws of the width Wr to the width Ws being equal to or more than 1.0. This can increase the rigidity of the root portion 22a of the sacrificial rib 22 and suppress unwanted early damage to the sacrificial rib 22. This helps to maintain wear suppression effect of the shoulder land portion 20 for a long period of time.

As used herein, as illustrated in FIG. 2, the root portion 22a of the sacrificial rib 22 is defined by a tire axial line extending outward from the groove bottom 12a which is the deepest position of the narrow groove 12. Further, the width Wr of the root portion 22a of the sacrificial rib 22 is specified as a distance in the tire axial direction from the groove bottom 12a of the narrow groove 12 to the outer surface of the tire 1. However, when the groove bottom 12a of the narrow groove 12 is continuous in the tire axial direction, the groove bottom 12a is specified as the outermost position in the tire axial direction. Furthermore, the width Ws of the top surface 22b of the sacrificial rib 22 in the tire axial direction is specified as a distance in the tire axial direction from the outer groove edge of the narrow groove 12 to the tread edge Te.

In order to further enhance the above-mentioned advantageous effect of sacrificial rib 22, it is preferable that the width of the sacrificial rib 22 in the tire axial direction decreases continuously from the root portion 22a to the top surface 22b.

In particular, the ratio (Wr/Ws) is preferably greater than 1.0, more preferably equal to or more than 1.5, even more preferably equal to or more than 2.0, for example.

On the other hand, when the ratio (Wr/Ws) becomes excessively large, the rigidity of the sacrificial rib 22 tends to be improved, but there is a risk that uneven wear suppression effect due to the original flexible deformation of the sacrificial rib 22 during running may not be obtained. From this point of view, it is preferable that the ratio (Wr/Ws) is, for example, equal to or less than 2.5.

Although not particularly limited, it is preferable that the width Ws of the top surface 22b of the sacrificial rib 22 in the tire axial direction is in a range of from 5 to 15 mm, for example.

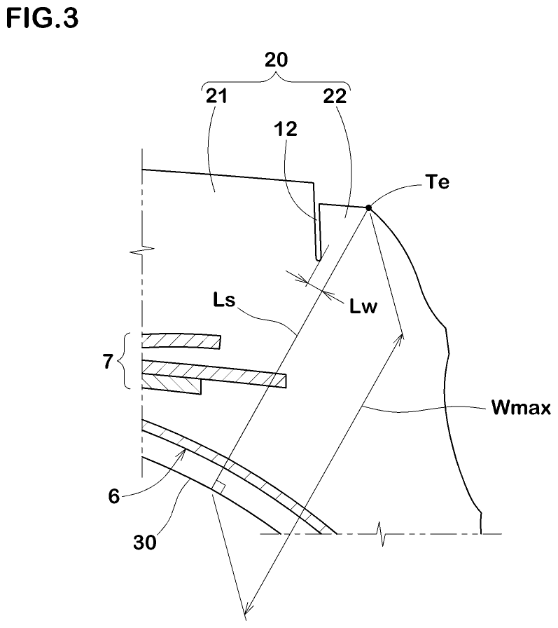

FIG. 3 is a partial enlarged view of one of the shoulder land portions 20 with the narrow groove 12. As illustrated in FIG. 3, in the tire 1 according to the present embodiment, a shortest distance Lw between the narrow groove 12 and the maximum thickness line Ls that defines the maximum thickness Wmax of the shoulder land portion 20 measured in the normal direction to the tire cavity surface 30 is equal to or less than 5.0 mm. In the present embodiment, the maximum thickness line Ls is a straight line that passes through the tread Te and is orthogonal to the tire cavity surface 30.

The heavy-duty pneumatic tire 1 tends to generate heat because the rubber volume of the shoulder land portions 20 as well as the deformation of the shoulder land portions 20 during load running is large. The heat stored in the shoulder land portions 20 affects the carcass 6 and the belt layer 7, causing looseness and separation thereto. In the present disclosure, in at least one of the shoulder land portions 20, by approaching the narrow groove 12 with the portion of the maximum thickness Wmax of the shoulder land portion 20 at a certain distance, the heat of the shoulder land portion 20 during running can be effectively dissipated to the outside of the tire 1 through the narrow groove 12. Thus, the tire 1 according to the present embodiment can improve heat generation durability.

When the shortest distance Lw is greater than 5.0 mm, the heat of the shoulder land portion 20 is difficult to be dissipated through the narrow groove 12, and the deterioration of heat generation durability cannot be effectively suppressed.

In some more preferred embodiments, the shortest distance Lw may be equal to or less than 1.0 mm. As a result, the portion of the maximum thickness Wmax of the shoulder land portion 20 can further approach the narrow groove 12, so that the heat dissipation effect of the shoulder land portion 20 during running can further be improved.

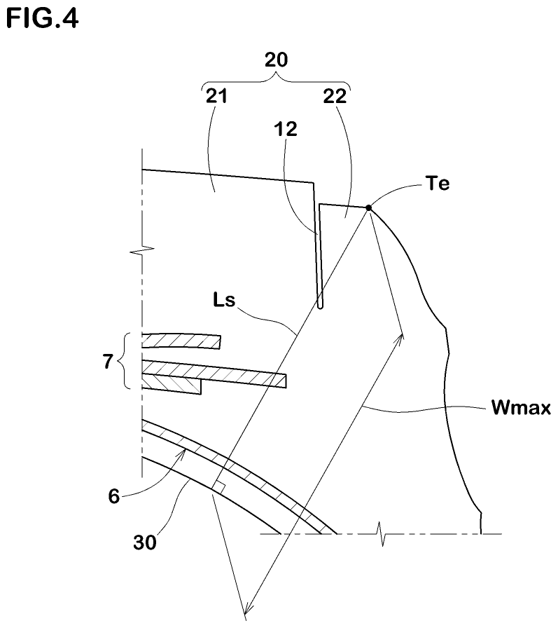

In some more preferred embodiments, as illustrated in FIG. 4, the maximum thickness line Ls of the shoulder land portion 20 may intersect the narrow groove 12. With this, the heat dissipation effect of the shoulder land portion 20 during running can further be improved.

As illustrated in FIG. 2, the top surface 22b of the sacrificial rib 22 is located inward in the tire radial direction with respect to a top surface 21b of the main portion 21 so as to form a step S therebetween. In such an embodiment, the height of the sacrificial rib 22 in the tire radial direction becomes smaller, and the bending rigidity of the sacrificial rib 22 can improve. This can improve crack resistance and tear resistance of the sacrificial rib 22. In particular, in such an embodiment, since the bending rigidity of the sacrificial rib 22 in the tire axial direction can be improved, the sacrificial rib 22 can come into contact with the main portion 21 to support the main portion 21 when the tire is running, reducing wear energy acting on the main portion 21. This helps to further reduce the uneven wear of the main portion 21 of the shoulder land portion 20.

In order to further improve the above-mentioned effect, the step S is preferably equal to or more than 2.0 mm as the distance in the tire radial direction. On the other hand, when the step S becomes excessively large, the sacrificial rib 22 may be difficult to come into contact with the ground during running so as not to be able to support the main portion 21. Thus, so-called sacrificial wear effect may be reduced. From this point of view, the step S, for example, preferable has the distance equal to or less than 3.0 mm.

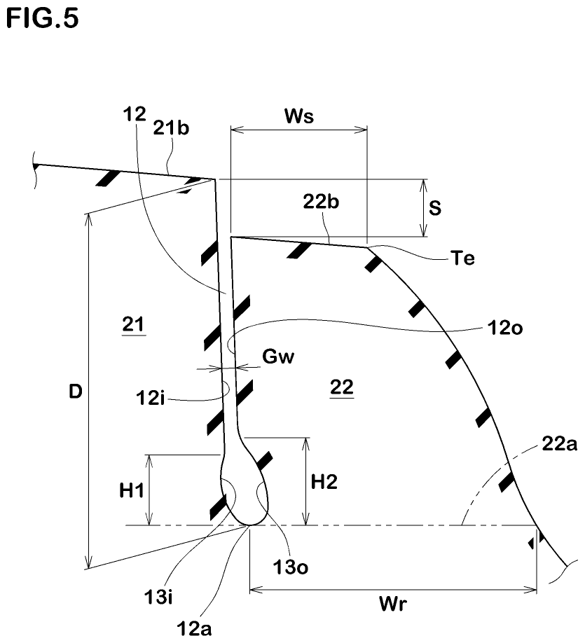

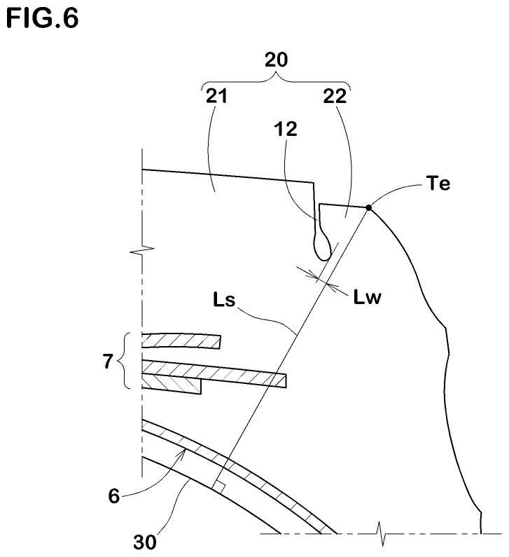

FIG. 5 and FIG. 6 are partial enlarged views of one of the shoulder land portions 20 in accordance with another embodiment. This embodiment differs from the previous embodiment in the shape of the narrow groove 12, and is basically the same except for that. Specifically, as illustrated in FIG. 5, the narrow groove 12 is different from the previous embodiment in that the narrow groove 12 is provided with a portion where the groove width is expanded on the groove bottom 12a side.

More specifically, in a cross-section of the narrow groove 12, the narrow groove 12 includes an inner groove wall 12i and an outer groove wall 12o in the tire axial direction. The inner groove wall 12i is provided with an inner recess 13i recessed inward in the tire axial direction on the groove bottom 12a side, and the outer groove wall 12o is provided with an outer recess 13o recessed outward in the tire axial direction on the groove bottom 12a side. In the present embodiment, both the inner recess 13i and the outer recess 13o have an arcuate concave curved surface, and both are smoothly connected to the groove bottom 12a.

Since the narrow groove 12 has an increased surface area, the heat stored in the shoulder land portion 20 can be more effectively dissipated to the outside of the tire. Thus, the heat generation durability of tire 1 can further be improved. In addition, the strain acting on the narrow groove 12 during running is widely dispersed in the inner recess 13i and the outer recess 13o, and the concentration of strain on the groove bottom 12a can be suppressed. Thus, in the present embodiment, crack resistance at the groove bottom 12a can be further improved. In the present embodiment, the groove bottom 12a of the narrow groove 12 is located outward in the tire axial direction than a virtual expanded line in which the outer groove wall 12o is expanded inward in the tire radial direction.

In the narrow groove 12 according to this embodiment, a portion of the narrow groove located outward in the tire radial direction of the inner recess 13i and the outer recess 13o has a relatively small groove width Gw. Thus, excessive deformation of the sacrificial rib 22 during running can be suppressed, and the development of uneven wear of the main portion 21 can be suppressed as before.

In some preferred embodiments, it is preferable that a height H1 (mm) from the groove bottom 12a to an outer end of the inner recess 13i in the tire radial direction is equal to or less than a height H2 (mm) from the groove bottom 12a to an outer end of the outer recess 13o in the tire radial direction. With such a configuration, the strain of the narrow groove 12 near the groove bottom 12a under load can be alleviated. As a result, damage to the sacrificial rib 22 due to cracking at the groove bottom 12a of the narrow groove 12 can be suppressed for a long period of time.

In some more preferred embodiments, it is preferable that the heights H1 and H2 satisfy the relationship of H1<H2. Thus, by forming the outer recess 13o larger in the tire radial direction than the inner recess 13i, the flexibility of the root portion 22a of the sacrificial rib 22 can further be improved. Thus, the crack resistance of the narrow groove 12 at the groove bottom 12a can further be improved, and the damage of the sacrificial rib 22 can further be suppressed.

In a particularly preferable embodiment, when “D” (mm) is a groove depth of the narrow groove, it is preferable that the heights H1 and H2 satisfy the following equation (1):

3.0 mm≤H1≤H2≤0.50*D (1).

When the equation (1) is satisfied, the inner recess 13i and the outer recess 13o are formed by a concave curved surface with a sufficiently large radius of curvature (e.g., R>=3.0 mm), and the above-mentioned effect can further be enhanced. In addition, when the heights H1 and H2 are equal to or less than 0.50*D, a significant decrease in the rigidity of the sacrificial rib 22 can be suppressed.

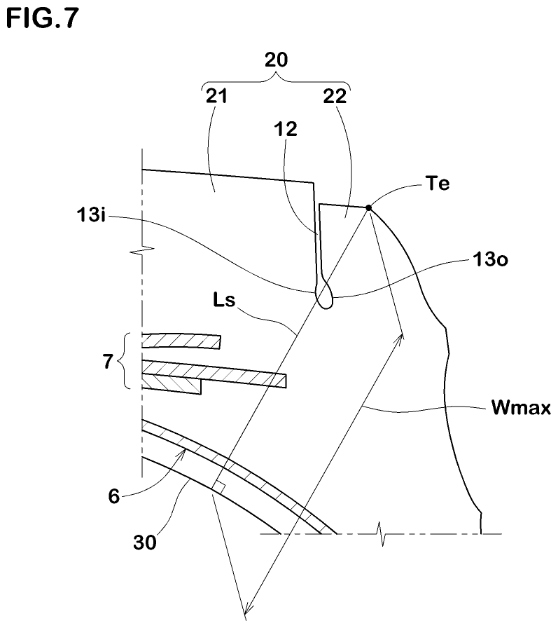

FIG. 7 illustrates a partial enlarged view of one of the shoulder land portions 20 in accordance with yet another embodiment. In this embodiment, the maximum thickness line Ls intersects the inner recess 13i or the outer recess 13o of the narrow groove 12. In this embodiment, the maximum thickness line Ls intersects both the inner recess 13i and the outer recess 13o of the narrow groove 12 where better heat dissipation effect can be expected. According to this embodiment, the heat stored in the shoulder land portion 20 can be dissipated outside of the tire 1 more effectively, and heat generation durability of the tire 1 can further be improved.

While the particularly preferable embodiments of the tire in accordance with the present disclosure have been described in detail, the present disclosure is not limited to the illustrated embodiments, but can be modified and carried out in various aspects within the scope of the disclosure.

### Working Example

Hereinafter, more specific and non-limited examples of the present disclosure will be described. Heavy-duty pneumatic tires with the basic structure shown in FIG. 1 were prepared based on the specifications in Table 1, and uneven wear resistance and heat generation durability of the shoulder land portions of each tire were tested. The common specifications and the test methods are as follows.

Tire size: 295/75R22.5

Rim size: 22.5×8.25

Inner pressure: 830 kPa

### [Uneven Wear Resistance Test for Shoulder Land Portions]

Each test tire was installed to all wheels of a 10-ton truck, and then the truck was run for 20000 km on an asphalt road test course. After that, the ratio of the wear amount of the main portions of the shoulder land portions to the wear amount of the land portions which are adjacent to the shoulder land portions inward in the tire axial direction was calculated. The test results are shown in Table 1 using the wear ratio*100, and the closer the value is to 100, the better the performance.

### [Heat Generation Durability Test]

A standard tire load (27.5 kN) was applied to each test tire and the tire was run on a drum tester. The speed was increased by 10 km/h every 120 minutes from 40 km/h, and the running time until the tire broke was measured. The test results are shown in Table 1 using an index with the running time of Reference 1 as 100, and the larger the value, the better the performance.

Table 1 shows the test results.

TABLE 1

| | Ref. 1 | Ref. 2 | Ref. 3 | Ex. 1 | Ex. 2 | Ex. 3 | Ex. 4 | Ex. 5 | Ex. 6 | Ex. 7 | Ex. 8 |
|---|---|---|---|---|---|---|---|---|---|---|---|
| Figure showing structure | — | — | — | FIG. 3 | FIG. 3 | FIG. 4 | FIG. 6 | FIG. 6 | FIG. 6 | FIG. 6 | FIG. 7 |
| of shoulder land portions | | | | | | | | | | | |
| Sacrificial ribs | applied | applied | applied | applied | applied | applied | applied | applied | applied | applied | applied |
| Widths Ws of top surface | 6 | 6 | 6 | 6 | 6 | 6 | 6 | 6 | 6 | 6 | 6 |
| of sacrificial ribs (mm) | | | | | | | | | | | |
| Ratio (Wr/Ws) | 0.5 | 1.0 | 0.5 | 1.0 | 1.0 | 1.0 | 1.5 | 1.5 | 2.5 | 2.5 | 2.0 |
| Shortest distance Lw (mm) | 7.5 | 7.5 | 5.0 | 5.0 | 1.0 | 0 | 5.0 | 1.0 | 5.0 | 1.0 | 0 |
| Step S (mm) | 0.1 | 0.1 | 0.1 | 0.1 | 0.1 | 0.1 | 0.1 | 0.1 | 0.1 | 0.1 | 0.1 |
| Height H1(mm) | 0 | 0 | 0 | 0 | 0 | 0 | 4.0 | 4.0 | 4.0 | 4.0 | 4.0 |
| Height H2(mm) | 0 | 0 | 0 | 0 | 0 | 0 | 4.5 | 4.5 | 4.5 | 4.5 | 4.5 |
| Uneven wear resistance of | 90 | 100 | 90 | 100 | 100 | 100 | 100 | 100 | 100 | 100 | 100 |
| shoulder land portions | | | | | | | | | | | |
| (wear ratio) | | | | | | | | | | | |
| Heat generation durability | 100 | 90 | 95 | 103 | 104 | 107 | 105 | 106 | 104 | 105 | 110 |
| (index) | | | | | | | | | | | |

From the test results, it was confirmed that the tires of the example improved heat generation durability while maintaining uneven wear resistance of the shoulder land portions to the same level as the tire of Reference examples.

Next, based on Example 1, the step between the main portions and the sacrificial ribs and the recesses in the groove walls of the narrow grooves were changed, and crack/tear resistance of the sacrificial ribs and groove bottom crack resistance of the narrow grooves were also tested. The test method is as follows.

### [Crack/Tear Resistance of Sacrificial Ribs, and Groove Bottom Crack Resistance of Narrow Grooves]

A standard tire load (27.5 kN) was applied to each test tire, and the tire was run on a drum tester having an asphalt road surface for running. The running speed was 40 km/h and the running time was 145 hours. After running, the degree of damage to the sacrificial ribs, the size of cracks at the narrow groove bottoms, and the degree of heat damage were quantified. The test results are shown in Table 2 using an index with Example 1 as 100, and the larger the value, the better the performance. The groove depth D of the narrow grooves was 15 mm.

Table 2 shows the test results.

TABLE 2

| | Ex. 1 | Ex. 7 | Ex. 8 | Ex. 9 | Ex. 10 | Ex. 11 | Ex. 12 |
|---|---|---|---|---|---|---|---|
| Figure showing structure | FIG. 3 | FIG. 6 | FIG. 6 | FIG. 6 | FIG. 6 | FIG. 6 | FIG. 6 |
| of shoulder land portions | | | | | | | |
| Step S (mm) | 0.1 | 1.0 | 2.0 | 3.0 | 2.5 | 2.5 | 2.5 |
| Height H1 (mm) | 0 | 4.0 | 4.0 | 4.0 | 2.0 | 3.0 | 4.0 |
| Height H2 (mm) | 0 | 4.5 | 4.5 | 4.5 | 2.0 | 3.0 | 4.5 |
| Groove bottom crack | 100 | 107 | 110 | 108 | 107 | 110 | 111 |
| resistance of narrow | | | | | | | |
| grooves (index) | | | | | | | |
| Crack/tear resistance of | 100 | 106 | 110 | 108 | 106 | 110 | 111 |
| sacrificial ribs (index) | | | | | | | |

In the aspect where the step is optimized between the main portions and the sacrificial ribs, or in the aspect where the recesses are provided on the groove bottom side of the narrow grooves, it was also confirmed that the crack/tear resistance of the sacrificial ribs and the groove bottom crack resistance of the narrow grooves were significantly improved.

The following clauses are disclosed regarding the above-described embodiments.

### [Clause 1]

A heavy-duty pneumatic tire comprising:

a tread portion being provided with a pair of shoulder circumferential grooves extending continuously in a tire circumferential direction and a pair of shoulder land portions disposed outward in a tire axial direction of the pair of shoulder circumferential grooves;

at least one of the pair of shoulder land portions being provided with a narrow groove extending continuously in the circumferential direction to divide the at least one of the shoulder land portions into a main portion located inward in the tire axial direction and a sacrificial rib located outward in the tire axial direction; and

the sacrificial rib comprising a root portion in a tire radial direction with a width Wr in the tire axial direction, a top surface in the tire radial direction with a width Ws in the axial direction, and a ratio Wr/Ws of the width Wr to the width Ws being equal to or more than 1.0, wherein

on the at least one of the pair of shoulder land portions, a shortest distance Lw between the narrow groove and a maximum thickness line that defines a maximum thickness of the at least one of the pair of shoulder land portions measured in a normal direction to a tire cavity surface is equal to or less than 5.0 mm.

### [Clause 2]

The heavy-duty pneumatic tire according to clause 1, wherein

the shortest distance Lw is equal to or less than 1.0 mm.

### [Clause 3]

The heavy-duty pneumatic tire according to clause 1 or 2, wherein

the maximum thickness line intersects the narrow groove.

### [Clause 4]

The heavy-duty pneumatic tire according to any one of clauses 1 to 3, wherein

the ratio Wr/Ws is in a range of from 1.5 to 2.5.

### [Clause 5]

The heavy-duty pneumatic tire according to any one of clauses 1 to 4, wherein

the main potion comprises a top surface in the tire radial direction, and

the top surface of the sacrificial rib is located inward in the tire radial direction with respect to the top surface of the main portion so as to form a step therebetween.

### [Clause 6]

The heavy-duty pneumatic tire according to clause 5, wherein

a radial height of the step is in a range of from 2.0 to 3.0 mm.

### [Clause 7]

The heavy-duty pneumatic tire according to any one of clauses 1 to 6, wherein

the narrow groove comprises a groove bottom,

in a cross-section of the narrow groove, the narrow groove comprises an inner groove wall and an outer groove wall in the tire axial direction,

the inner groove wall is provided with an inner recess recessed inward in the tire axial direction on a groove bottom side, and

the outer groove wall is provided with an outer recess recessed outward in the tire axial direction on a groove bottom side.

### [Clause 8]

The heavy-duty pneumatic tire according to clause 7, wherein

a height H1 (mm) from the groove bottom to an outer end of the inner recess in the tire radial direction is equal to or less than a height H2 (mm) from the groove bottom to an outer end of the outer recess in the tire radial direction.

### [Clause 9]

The heavy-duty pneumatic tire according to clause 7 or 8, wherein

a height H1 (mm) from the groove bottom to an outer edge of the inner recess in the tire radial direction is smaller than a height H2 (mm) from the groove bottom to an outer edge of the outer recess in the tire radial direction.

### [Clause 10]

The heavy-duty pneumatic tire according to clause 8, wherein

when a groove depth of the narrow groove is “D” (mm), the heights H1 and H2 satisfy the following equation (1):

3.0 mm≤H1≤H2≤0.50*D (1).

### [Clause 11]

The heavy-duty pneumatic tire according to any one of the clauses 7 to 10, wherein the maximum thickness line intersects the inner recess or the outer recess of the narrow groove.

1. A heavy-duty pneumatic tire comprising:
a tread portion being provided with a pair of shoulder circumferential grooves extending continuously in a tire circumferential direction and a pair of shoulder land portions disposed outward in a tire axial direction of the pair of shoulder circumferential grooves;
at least one of the pair of shoulder land portions being provided with a narrow groove extending continuously in the tire circumferential direction to divide the at least one of the shoulder land portions into a main portion located inward in the tire axial direction and a sacrificial rib located outward in the tire axial direction; and
the sacrificial rib comprising a root portion in a tire radial direction with a width Wr in the tire axial direction, a top surface in the tire radial direction with a width Ws in the tire axial direction, and a ratio Wr/Ws of the width Wr to the width Ws being equal to or more than 1.0, wherein
in the at least one of the pair of shoulder land portions, a shortest distance Lw between the narrow groove and a maximum thickness line that defines a maximum thickness of the at least one of the pair of shoulder land portions measured in a normal direction to a tire cavity surface is equal to or less than 5.0 mm.

2. The heavy-duty pneumatic tire according to claim 1, wherein
the shortest distance Lw is equal to or less than 1.0 mm.

3. The heavy-duty pneumatic tire according to claim 1, wherein
the maximum thickness line intersects the narrow groove.

4. The heavy-duty pneumatic tire according to claim 1, wherein
the ratio Wr/Ws is in a range of from 1.5 to 2.5.

5. The heavy-duty pneumatic tire according to claim 1, wherein
the main potion comprises a top surface in the tire radial direction, and the top surface of the sacrificial rib is located inward in the tire radial direction with respect to the top surface of the main portion so as to form a step therebetween.

6. The heavy-duty pneumatic tire according to claim 5, wherein
a radial height of the step is in a range of from 2.0 to 3.0 mm.

7. The heavy-duty pneumatic tire according to claim 1, wherein
the narrow groove comprises a groove bottom,
in a cross-section of the narrow groove, the narrow groove comprises an inner groove wall and an outer groove wall in the tire axial direction,
the inner groove wall is provided with an inner recess recessed inward in the tire axial direction on a groove bottom side, and
the outer groove wall is provided with an outer recess recessed outward in the tire axial direction on a groove bottom side.

8. The heavy-duty pneumatic tire according to claim 7, wherein
a height H1 (mm) from the groove bottom to an outer end of the inner recess in the tire radial direction is equal to or less than a height H2 (mm) from the groove bottom to an outer end of the outer recess in the tire radial direction.

9. The heavy-duty pneumatic tire according to claim 7, wherein
a height H1 (mm) from the groove bottom to an outer edge of the inner recess in the tire radial direction is smaller than a height H2 (mm) from the groove bottom to an outer edge of the outer recess in the tire radial direction.

10. The heavy-duty pneumatic tire according to claim 8, wherein
when a groove depth of the narrow groove is “D” (mm), the heights H1 and H2 satisfy the following equation (1):
3.0 mm≤H1≤H2≤0.50*D (1).

11. The heavy-duty pneumatic tire according to claim 7, wherein
the maximum thickness line intersects the inner recess or the outer recess of the narrow groove.

12. The heavy-duty pneumatic tire according to claim 2, wherein
the ratio Wr/Ws is in a range of from 1.5 to 2.5.

13. The heavy-duty pneumatic tire according to claim 3, wherein
the ratio Wr/Ws is in a range of from 1.5 to 2.5.

14. The heavy-duty pneumatic tire according to claim 2, wherein
the narrow groove comprises a groove bottom,
in a cross-section of the narrow groove, the narrow groove comprises an inner groove wall and an outer groove wall in the tire axial direction,
the inner groove wall is provided with an inner recess recessed inward in the tire axial direction on a groove bottom side, and
the outer groove wall is provided with an outer recess recessed outward in the tire axial direction on a groove bottom side.

15. The heavy-duty pneumatic tire according to claim 3, wherein
the narrow groove comprises a groove bottom,
in a cross-section of the narrow groove, the narrow groove comprises an inner groove wall and an outer groove wall in the tire axial direction,
the inner groove wall is provided with an inner recess recessed inward in the tire axial direction on a groove bottom side, and
the outer groove wall is provided with an outer recess recessed outward in the tire axial direction on a groove bottom side.

16. The heavy-duty pneumatic tire according to claim 4, wherein
the narrow groove comprises a groove bottom,
in a cross-section of the narrow groove, the narrow groove comprises an inner groove wall and an outer groove wall in the tire axial direction,
the inner groove wall is provided with an inner recess recessed inward in the tire axial direction on a groove bottom side, and
the outer groove wall is provided with an outer recess recessed outward in the tire axial direction on a groove bottom side.

17. The heavy-duty pneumatic tire according to claim 5, wherein
the narrow groove comprises a groove bottom,
in a cross-section of the narrow groove, the narrow groove comprises an inner groove wall and an outer groove wall in the tire axial direction,
the inner groove wall is provided with an inner recess recessed inward in the tire axial direction on a groove bottom side, and
the outer groove wall is provided with an outer recess recessed outward in the tire axial direction on a groove bottom side.

18. The heavy-duty pneumatic tire according to claim 6, wherein
the narrow groove comprises a groove bottom,
in a cross-section of the narrow groove, the narrow groove comprises an inner groove wall and an outer groove wall in the tire axial direction,
the inner groove wall is provided with an inner recess recessed inward in the tire axial direction on a groove bottom side, and
the outer groove wall is provided with an outer recess recessed outward in the tire axial direction on a groove bottom side.

19. The heavy-duty pneumatic tire according to claim 1, wherein
the narrow groove comprises a groove bottom,
in a cross-section of the narrow groove, the narrow groove comprises an inner groove wall and an outer groove wall in the tire axial direction,
the inner groove wall is provided with an inner recess recessed inward in the tire axial direction on a groove bottom side,
the outer groove wall is provided with an outer recess recessed outward in the tire axial direction on a groove bottom side, and
the groove bottom of the narrow groove is located outward in the tire axial direction than a virtual expanded line in which the outer groove wall is expanded inward in the tire radial direction.
